(19) United States
(12) Patent Application Publication
(10) Pub. No.: US 2023/0098436 A1
(43) Pub. Date: Mar. 30, 2023

(54) TRANSMISSION OF BUFFER INFORMATION FOR MULTI-LINK OPERATION

(71) Applicant: LG ELECTRONICS INC., Seoul (KR)

(72) Inventors: Insun JANG, Seoul (KR); Jeongki KIM, Seoul (KR); Jinsoo CHOI, Seoul (KR); Namyeong KIM, Seoul (KR); Taewon SONG, Seoul (KR)

(21) Appl. No.: 17/928,518

(22) PCT Filed: Jun. 1, 2021
(86) PCT No.: PCT/KR2021/006784

§ 371 Date: Nov. 29, 2022

(30) Foreign Application Priority Data
Jun. 1, 2020 (KR) 10-2020-0065938
Sep. 14, 2020 (KR) 10-2020-0117839

(51) Int. Cl. H04W 28/02; H04W 76/15

(52) U.S. Cl. CPC H04W 28/0263; H04W 28/0278; H04W 76/15

(57) ABSTRACT

An STA MLD can receive traffic indication map (TIM) information from an access point (AP) MLD in a wireless local area network (LAN) system. The TIM information can include a TIM bitmap and a link bitmap. The TIM bitmap includes a bitmap related to whether data to be transmitted by the AP MLD to each receiving MLD is present, and the receiving MLD can include the STA MLD. The link bitmap can include information related to a link of the receiving MLD, in which the data to be transmitted by the AP MLD is present, from among the receiving MLDs. The STA MLD can receive wake-up link information from the AP MLD. The wake-up link information can include information related to a link to be woken up from among links of the STA MLD.

### TECHNICAL FIELD

The present specification relates to a method of transmitting buffer information for multi-link operation in a wireless local area network (WLAN) system, and more particularly, to an operation of selecting a link to be woken up based on buffer information.

### BACKGROUND

A wireless local area network (WLAN) has been improved in various ways. For example, the IEEE 802.11ax standard proposed an improved communication environment using orthogonal frequency division multiple access (OFDMA) and downlink multi-user multiple input multiple output (DL MU MIMO) techniques.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

### SUMMARY

According to various embodiments, in a Wireless Local Area Network (WLAN) system a STA MLD may receive traffic indication map (TIM) information from an access point (AP) MLD. The TIM information may include a TIM bitmap and a link bitmap. The TIM bitmap may include a bitmap related to whether data to be transmitted by the AP MLD to each receiving MLD is present, the receiving MLD may include the STA MLD. The link bitmap may include information related to a link of the receiving MLD, in which the data to be transmitted by the AP MLD is present, from among the receiving MLDs. The STA MLD may receive wake-up link information from an AP MLD. The wake-up link information may include information related to a link to be woken up from among links of the STA MLD.

According to an example of this specification, by indicating TIM information for other links, power efficiency in terms of MLD can be increased. Since wake-up link information can be indicated in consideration of TID to link mapping as well as buffer data, if the minimum link requiring wake-up is indicated or only some of the links with data to be received are awakened, it is possible to prevent a case in which all data is not received.

### BRIEF DESCRIPTION OF THE DRAWINGS

FIG. 1 shows an example of a transmitting apparatus and/or receiving apparatus of the present specification.

FIG. 2 is a conceptual view illustrating the structure of a wireless local area network (WLAN).

FIG. 3 illustrates a general link setup process.

FIG. 4 illustrates a layout of resource units (RUs) used in a band of 80 MHz.

FIG. 5 illustrates an example of a PPDU used in the present specification.

FIG. 6 illustrates an example of a modified transmission device and/or receiving device of the present specification.

FIG. 7 is a diagram illustrating an embodiment of a device supporting multi-link.

FIG. 8 is a diagram showing an example of a TIM bitmap.

FIG. 9 is a diagram showing an example of a TIM bitmap.

FIG. 10 is a diagram showing an example of a TIM bitmap.

FIG. 11 is a diagram illustrating an embodiment of a STA MLD operation method.

FIG. 12 is a diagram illustrating an embodiment of an AP MLD operating method.

### DESCRIPTION OF EXEMPLARY EMBODIMENTS

In the present specification, “A or B” may mean “only A”, “only B” or “both A and B”. In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (EHT-signal)”, it may mean that “EHT-signal” is proposed as an example of the “control information”. In other words, the “control information” of the present specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in the present specification may be individually implemented, or may be simultaneously implemented.

The following example of the present specification may be applied to various wireless communication systems. For example, the following example of the present specification may be applied to a wireless local area network (WLAN) system. For example, the present specification may be applied to the IEEE 802.11a/g/n/ac standard or the IEEE 802.11ax standard. In addition, the present specification may also be applied to the newly proposed EHT standard or IEEE 802.11be standard. In addition, the example of the present specification may also be applied to a new WLAN standard enhanced from the EHT standard or the IEEE 802.11be standard. In addition, the example of the present specification may be applied to a mobile communication system. For example, it may be applied to a mobile communication system based on long term evolution (LTE) depending on a 3rd generation partnership project (3GPP) standard and based on evolution of the LTE. In addition, the example of the present specification may be applied to a communication system of a 5G NR standard based on the 3GPP standard.

Hereinafter, in order to describe a technical feature of the present specification, a technical feature applicable to the present specification will be described.

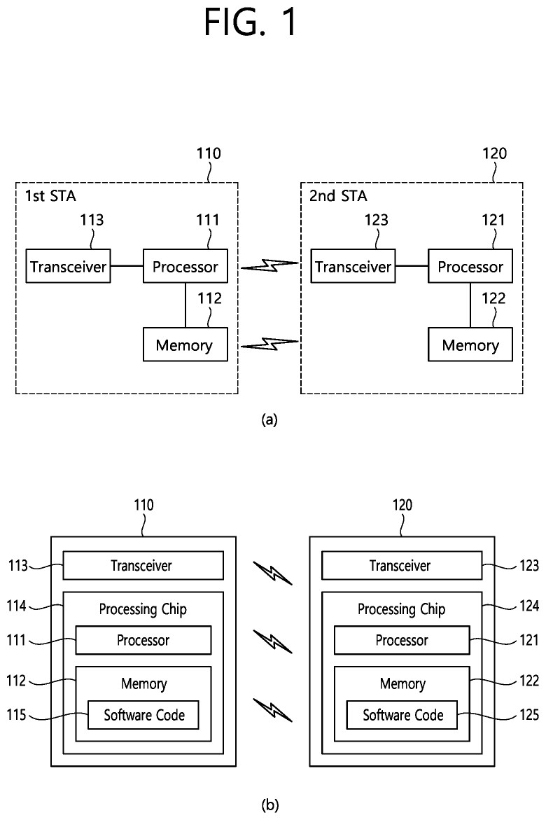

FIG. 1 shows an example of a transmitting apparatus and/or receiving apparatus of the present specification.

In the example of FIG. 1, various technical features described below may be performed. FIG. 1 relates to at least one station (STA). For example, STAs 110 and 120 of the present specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present specification may also be called in various terms such as a network, a base station, a node-B, an access point (AP), a repeater, a router, a relay, or the like. The STAs 110 and 120 of the present specification may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present specification may serve as the AP and/or the non-AP. In the present specification, the AP may be indicated as an AP STA.

The STAs 110 and 120 of the present specification may support various communication standards together in addition to the IEEE 802.11 standard. For example, a communication standard (e.g., LTE, LTE-A, 5G NR standard) or the like based on the 3GPP standard may be supported. In addition, the STA of the present specification may be implemented as various devices such as a mobile phone, a vehicle, a personal computer, or the like. In addition, the STA of the present specification may support communication for various communication services such as voice calls, video calls, data communication, and self-driving (autonomous-driving), or the like.

The STAs 110 and 120 of the present specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of the present specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present specification, an uplink may imply a link for communication from a non-AP STA to an SP STA, and an uplink PPDU/packet/signal or the like may be transmitted through the uplink. In addition, in the present specification, a downlink may imply a link for communication from the AP STA to the non-AP STA, and a downlink PPDU/packet/signal or the like may be transmitted through the downlink.

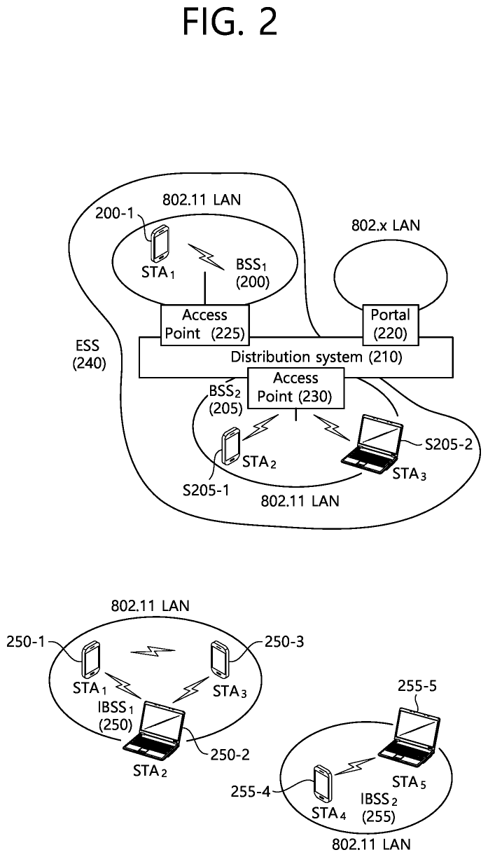

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and an STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

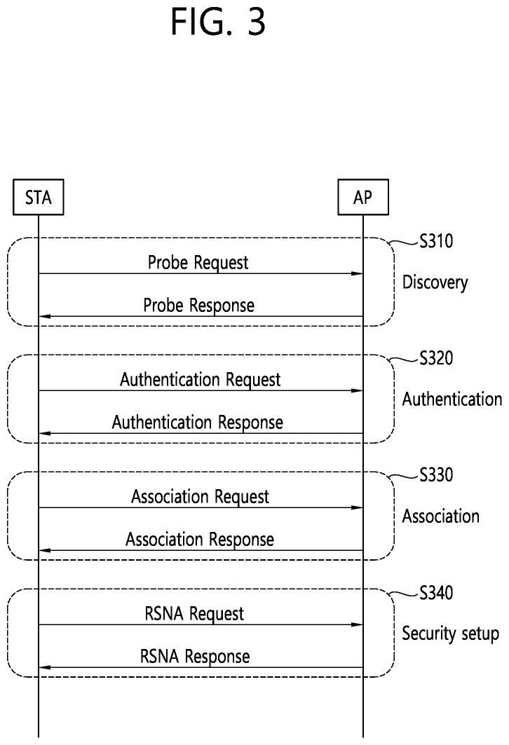

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

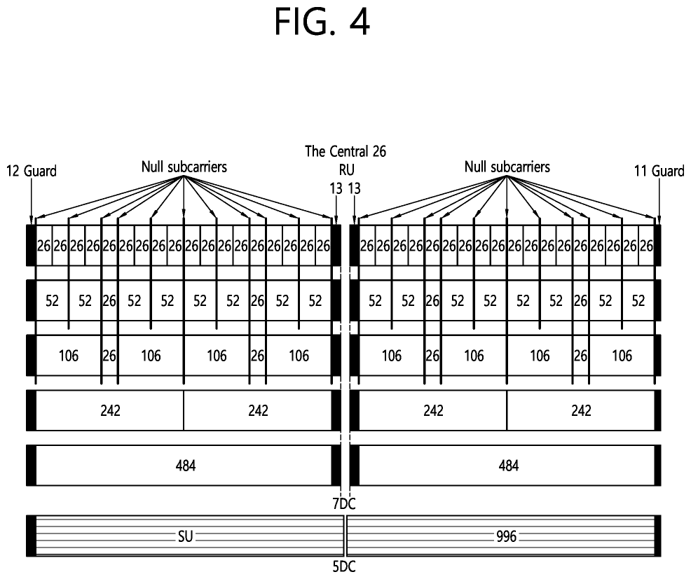

FIG. 4 illustrates a layout of resource units (RUs) used in a band of 80 MHz.

RUs having various sizes such as a 26-RU, a 52-RU, a 106-RU, a 242-RU, a 484-RU, a 996-RU may be used. Further, seven DC tones may be inserted in the center frequency, 12 tones may be used for a guard band in the leftmost band of the 80 MHz band, and 11 tones may be used for a guard band in the rightmost band of the 80 MHz band. In addition, a 26-RU corresponding to 13 tones on each of the left and right sides of the DC band may be used.

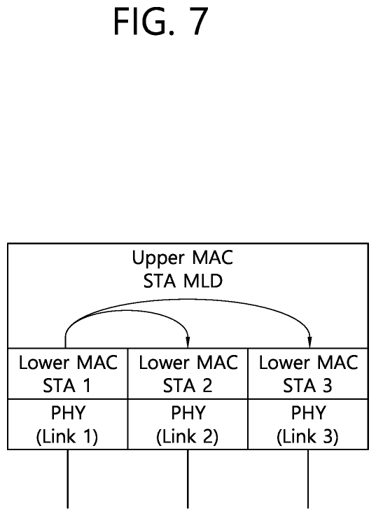

As illustrated in FIG. 7, when the layout of the RUs is used for a single user, a 996-RU may be used, in which case five DC tones may be inserted.

The RU described in the present specification may be used in uplink (UL) communication and downlink (DL) communication. For example, when UL-MU communication which is solicited by a trigger frame is performed, a transmitting STA (e.g., AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU. etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

Information related to a layout of the RU may be signaled through HE-SIG-B.

Hereinafter, a PPDU transmitted/received in a STA of the present specification will be described.

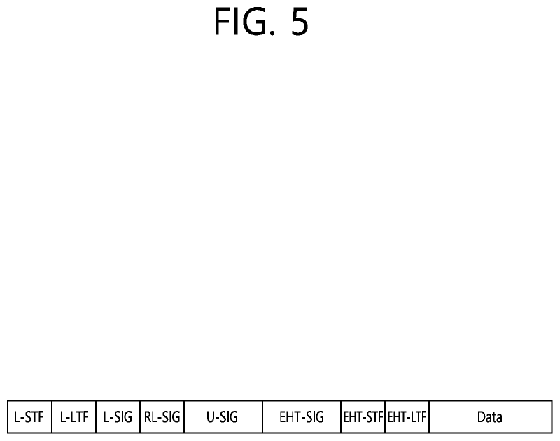

FIG. 5 illustrates an example of a PPDU used in the present specification.

The PPDU of FIG. 5 may be called in various terms such as an EHT PPDU, a TX PPDU, an RX PPDU, a first type or N-th type PPDU, or the like. For example, in the present specification, the PPDU or the EHT PPDU may be called in various terms such as a TX PPDU, a RX PPDU, a first type or N-th type PPDU, or the like. In addition, the EHT PPDU may be used in an EHT system and/or a new WLAN system enhanced from the EHT system.

The PPDU of FIG. 5 may indicate the entirety or part of a PPDU type used in the EHT system. For example, the example of FIG. 5 may be used for both of a single-user (SU) mode and a multi-user (MU) mode. In other words, the PPDU of FIG. 5 may be a PPDU for one receiving STA or a plurality of receiving STAs. When the PPDU of FIG. 5 is used for a trigger-based (TB) mode, the EHT-SIG of FIG. 5 may be omitted. In other words, a STA which has received a trigger frame for uplink-MU (UL-MU) may transmit the PPDU in which the EHT-SIG is omitted in the example of FIG. 5.

In FIG. 5, an L-STF to an EHT-LTF may be called a preamble or a physical preamble, and may be generated/transmitted/received/obtained/decoded in a physical layer.

A subcarrier spacing of the L-STF, L-LTF, L-SIG, RL-SIG, U-SIG, and EHT-SIG fields of FIG. 5 may be determined as 312.5 kHz, and a subcarrier spacing of the EHT-STF, EHT-LTF, and Data fields may be determined as 78.125 kHz. That is, a tone index (or subcarrier index) of the L-STF, L-LTF, L-SIG, RL-SIG, U-SIG, and EHT-SIG fields may be expressed in unit of 312.5 kHz, and a tone index (or subcarrier index) of the EHT-STF, EHT-LTF, and Data fields may be expressed in unit of 78.125 kHz.

In the PPDU of FIG. 5, the L-LTF and the L-STF may be the same as those in the conventional fields.

The transmitting STA may generate an RL-SIG generated in the same manner as the L-SIG. BPSK modulation may be applied to the RL-SIG. The receiving STA may know that the RX PPDU is the HE PPDU or the EHT PPDU, based on the presence of the RL-SIG.

A universal SIG (U-SIG) may be inserted after the RL-SIG of FIG. 5. The U-SIG may be called in various terms such as a first SIG field, a first SIG, a first type SIG, a control signal, a control signal field, a first (type) control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 μs. Each symbol of the U-SIG may be used to transmit the 26-bit information. For example, each symbol of the U-SIG may be transmitted/received based on 52 data tomes and 4 pilot tones.

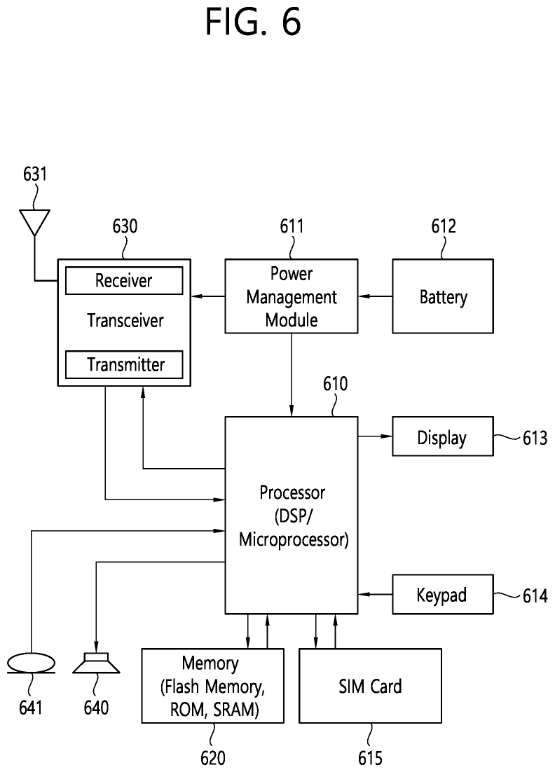

The common field of the EHT-SIG and the user-specific field of the EHT-SIG may be individually coded. One user block field included in the user-specific field may include information for two users, but a last user block field included in the user-specific field may include information for one user. That is, one user block field of the EHT-SIG may include up to two user fields. As in the example of FIG. 6, each user field may be related to MU-MIMO allocation, or may be related to non-MU-MIMO allocation.

The common field of the EHT-SIG may include a CRC bit and a tail bit. A length of the CRC bit may be determined as 4 bits. A length of the tail bit may be determined as 6 bits, and may be set to ‘000000’.

The common field of the EHT-SIG may include RU allocation information. The RU allocation information may imply information related to a location of an RU to which a plurality of users (i.e., a plurality of receiving STAs) are allocated. The RU allocation information may be configured in unit of 8 bits (or N bits), as in Table 1.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 5. The PPDU of FIG. 5 may be used to transmit/receive frames of various types. For example, the PPDU of FIG. 5 may be used for a control frame. An example of the control frame may include a request to send (RTS), a clear-to-send (CTS), a power save-poll (PS-poll), BlockACKReq, BlockAck, a null data packet (NDP) announcement, and a trigger frame. For example, the PPDU of FIG. 5 may be used for a management frame. An example of the management frame may include a beacon frame, a (re-)association request frame, a (re-)association response frame, a probe request frame, and a probe response frame. For example, the PPDU of FIG. 5 may be used for a data frame. For example, the PPDU of FIG. 5 may be used to simultaneously transmit at least two or more of the control frame, the management frame, and the data frame.

FIG. 6 illustrates an example of a modified transmission device and/or receiving device of the present specification.

Each device/STA of the sub-figure (a)/(b) of FIG. 1 may be modified as shown in FIG. 6. A transceiver 630 of FIG. 6 may be identical to the transceivers 113 and 123 of FIG. 1. The transceiver 630 of FIG. 6 may include a receiver and a transmitter.

A processor 610 of FIG. 6 may be identical to the processors 111 and 121 of FIG. 1. Alternatively, the processor 610 of FIG. 6 may be identical to the processing chips 114 and 124 of FIG. 1.

A memory 620 of FIG. 6 may be identical to the memories 112 and 122 of FIG. 1. Alternatively, the memory 620 of FIG. 6 may be a separate external memory different from the memories 112 and 122 of FIG. 1.

Referring to FIG. 6, a power management module 611 manages power for the processor 610 and/or the transceiver 630. A battery 612 supplies power to the power management module 611. A display 613 outputs a result processed by the processor 610. A keypad 614 receives inputs to be used by the processor 610. The keypad 614 may be displayed on the display 613. A SIM card 615 may be an integrated circuit which is used to securely store an international mobile subscriber identity (IMSI) and its related key, which are used to identify and authenticate subscribers on mobile telephony devices such as mobile phones and computers.

Referring to FIG. 6, a speaker 640 may output a result related to a sound processed by the processor 610. A microphone 641 may receive an input related to a sound to be used by the processor 610.

EHT (11be) may consider multi-link technology, where multi-link may include multi-band. That is, multi-link can represent links of several bands and a plurality of multi-links within one band at the same time.

FIG. 7 is a diagram illustrating an embodiment of a device supporting multi-link.

Referring to FIG. 7, an STA multi-link device (MLD) may have three links. That is, the STA MLD may include three STAs operating in each link. Each STA has a Lower MAC and a PHY layer, and can be coordinated through the Upper MAC. That is, as shown in FIG. 7, STA 1 may share various information such as status, operation, and collected data on link 1 with STAs 2 and 3 through Upper MAC.

Hereinafter, the technical features of a multi-link (ML) supported by a STA of the present disclosure will be described.

The STA (AP and/or non-AP STA) of the present disclosure may support multi-link (ML) communication. ML communication may refer to communication supporting a plurality of links. The link related to ML communication may include channels of the 2.4 GHz band shown, the 5 GHz band, and the 6 GHz band (for example, 20/40/80/160/240/320 MHz channels).

Hereinafter, the technical features of a multi-link (ML) supported by a STA of the present disclosure will be described.

The STA (AP and/or non-AP STA) of the present disclosure may support multi-link (ML) communication. ML communication may refer to communication supporting a plurality of links. The link related to ML communication may include channels of the 2.4 GHz band shown, the 5 GHz band, and the 6 GHz band (for example, 20/40/80/160/240/320 MHz channels).

A plurality of links used for ML communication may be set in various ways. For example, a plurality of links supported by one STA for ML communication may be a plurality of channels in a 2.4 GHz band, a plurality of channels in a 5 GHz band, and a plurality of channels in a 6 GHz band. Alternatively, a plurality of links supported by one STA for ML communication may be a combination of at least one channel in the 2.4 GHz band (or 5 GHz/6 GHz band) and at least one channel in the 5 GHz band (or 2.4 GHz/6 GHz band). Meanwhile, at least one of the plurality of links supported by one STA for ML communication may be a channel to which preamble puncturing is applied.

The STA may perform an ML setup to perform ML communication. The ML setup may be performed based on a management frame or control frame such as a Beacon, a Probe Request/Response, an Association Request/Response, and the like. For example, information about ML setup may be included in an element field included in a Beacon, a Probe Request/Response, an Association Request/Response, and the like.

When ML setup is completed, an enabled link for ML communication may be determined. The STA may perform frame exchange through at least one of a plurality of links determined as an enabled link. For example, the enabled link may be used for at least one of a management frame, a control frame, and a data frame.

When one STA supports multiple links, a transceiver supporting each link may operate as one logical STA. For example, one STA supporting two links may be expressed as one Multi-Link Device (MLD) including a first STA for the first link and a second STA for the second link. For example, one AP supporting two links may be expressed as one AP MLD including a first AP for a first link and a second AP for a second link. In addition, one non-AP supporting two links may be expressed as one non-AP MLD including a first STA for the first link and a second STA for the second link.

Hereinafter, more specific features related to the ML setup are described.

The MLD (AP MLD and/or non-AP MLD) may transmit, through ML setup, information on a link that the corresponding MLD can support. Link information may be configured in various ways. For example, information on the link may include at least one of 1) information on whether the MLD (or STA) supports simultaneous RX/TX operation, 2) information on the number/upper limit of uplink/downlink links supported by the MLD (or STA), 3) information on the location/band/resource of the uplink/downlink Link supported by the MLD (or STA), 4) information on the frame type (management, control, data, etc.) available or preferred in at least one uplink/downlink link, 5) information on ACK policy available or preferred in at least one uplink/downlink link, and 6) information on an available or preferred traffic identifier (TID) in at least one uplink/downlink Link. The TID is related to the priority of traffic data and is expressed as eight types of values according to the conventional wireless LAN standard. That is, eight TID values corresponding to four access categories (ACs) (AC_Background (AC_BK), AC_Best Effort (AC_BE), AC_Video (AC_VI), AC_Voice (AC_VO)) according to the conventional WLAN standard may be defined.

For example, it may be preset that all TIDs are mapped for uplink/downlink links. Specifically, if negotiation is not made through ML setup, if all TIDs are used for ML communication, and if the mapping between uplink/downlink link and TID is negotiated through additional ML settings, the negotiated TID may be used for ML communication.

Through ML setup, a plurality of links usable by the transmitting MLD and the receiving MLD related to ML communication may be set, and this may be referred to as an “enabled link”. The “enabled link” may be called differently in various expressions. For example, it may be referred to as various expressions such as a first link, a second link, a transmission link, and a reception link.

After the ML setup is completed, the MLD could update the ML setup. For example, the MLD may transmit information on a new link when it is necessary to update information on the link. Information on the new link may be transmitted based on at least one of a management frame, a control frame, and a data frame.

In extreme high throughput (EHT), a standard being discussed after IEEE802.11ax, the introduction of HARQ is being considered. When HARQ is introduced, coverage can be expanded in a low signal-to-noise ratio (SNR) environment, that is, in an environment where the distance between the transmitting terminal and the receiving terminal is long, and higher throughput may be obtained in a high SNR environment.

The device described below may be the apparatus of FIGS. 1, 6, and/or 7, and the PPDU may be the PPDU of FIG. 5. A device may be an AP or a non-AP STA. The device described below may be an AP multi-link device (MLD) supporting multi-link or a non-AP STA MLD.

In extremely high throughput (EHT), a standard being discussed after 802.11ax, a multi-link environment using one or more bands at the same time is being considered. When the device supports multi-link or multi-link, the device may use one or more bands (for example, 2.4 GHz, 5 GHz, 6 GHz, 60 GHz, etc.) simultaneously or alternately.

Hereinafter, although described in the form of a multi-link, the frequency band may be configured in various other forms. In this specification, terms such as multi-link, multi-link, and the like may be used, however, for the convenience of the description below, some embodiments may be described based on multi-link.

In the following specification, an MLD refers to a multi-link device. The MLD has one or more connected STAs and one MAC service access point (SAP) that connects to an upper link layer (Logical Link Control, LLC). An MLD may mean a physical device or a logical device. Hereinafter, a device may mean an MLD.

In the following specification, a transmitting device and a receiving device may refer to an MLD. The first link of the receiving/transmitting device may be a terminal (for example, STA or AP) that performs signal transmission/reception through the first link included in the receiving/transmitting device. The second link of the receiving/transmitting device may be a terminal (for example, STA or AP) that performs signal transmission/reception through the second link included in the receiving/transmitting device.

IEEE802.11be can support two types of multi-link operations. For example, simultaneous transmit and receive (STR) and non-STR operations may be considered. For example, an STR may be referred to as an asynchronous multi-link operation, and a non-STR may be referred to as a synchronous multi-link operation. A multi-link may include a multi-band. That is, the multi-link may mean links included in several frequency bands, or may mean a plurality of links included in one frequency band.

EHT (11be) may consider multi-link technology, where multi-link may include multi-band. That is, the multi-link may represent links of several bands and at the same time may represent several multi-links within one band. Two types of multi-link operations are being considered. A capability enabling simultaneous reception and transmission on multiple links may be referred to as simultaneous transmit and receive (STR). Links having STR capability can be said to be in an STR relationship. Links that do not have STR capability can be said to be in a non-STR relationship.

Meanwhile, the existing traffic indication map (TIM) is defined for single-link, and it needs to be extended from the MLD point of view. Therefore, in this specification, a TIM transmission method in a multi-link environment will be described.

Only some STAs, not all STAs included in the MLD (for example, non-AP MLD), can monitor beacons in the link in which it operates. For example, a non-AP MLD can monitor beacons only on some links. In this case, the beacon frame needs to indicate the presence or absence of DL traffic on a link not monitored by the MLD. For example, if the non-AP MLD monitors only link 1 when there are three links (for example, links 1, 2, and 3), the AP MLD needs to inform the non-AP MLD of the presence or absence of traffic that can be transmitted on link 2 and link 3 through link 1. Therefore, the TIM indication method needs to be extended to multi-link. That is, a TIM indication method needs to be newly defined in a multi-link environment.

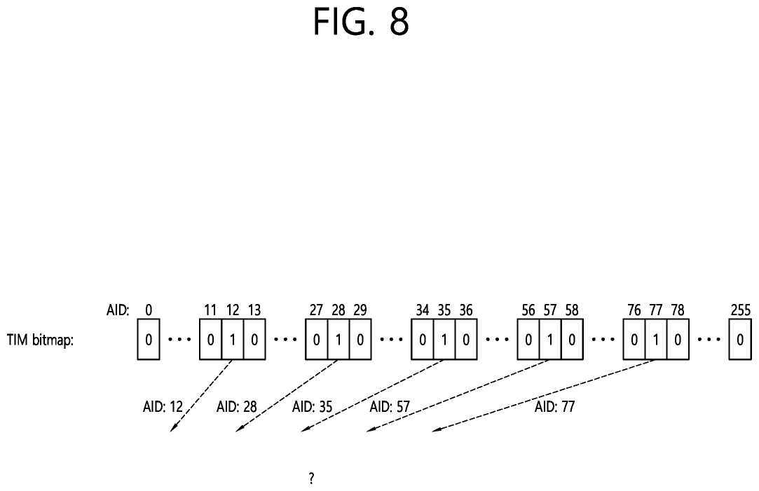

FIG. 8 is a diagram showing an example of a TIM bitmap.

Referring to FIG. 8, the AP MLD may indicate the presence or absence of traffic for the non-AP MLD of the corresponding AID. That is, the AP MLD may indicate for each AID whether there is traffic to be transmitted to the non-AP MLD corresponding to each AID. For example, the TIM bitmap may include information related to whether there is traffic to be transmitted to a non-AP MLD corresponding to each AID. For example, if the bit value mapped to AID 12 is 1, it may mean that traffic to be transmitted from the AP MLD to the non-AP MLD corresponding to AID 12 is present. That is, if the bit value is 1, it may mean that there is traffic for the corresponding AID regardless of the TID/link.

Here, for non-AP MLDs with an AID whose TIM bitmap is “1”, additional instructions can be specifically given in the following way, but are not limited thereto.

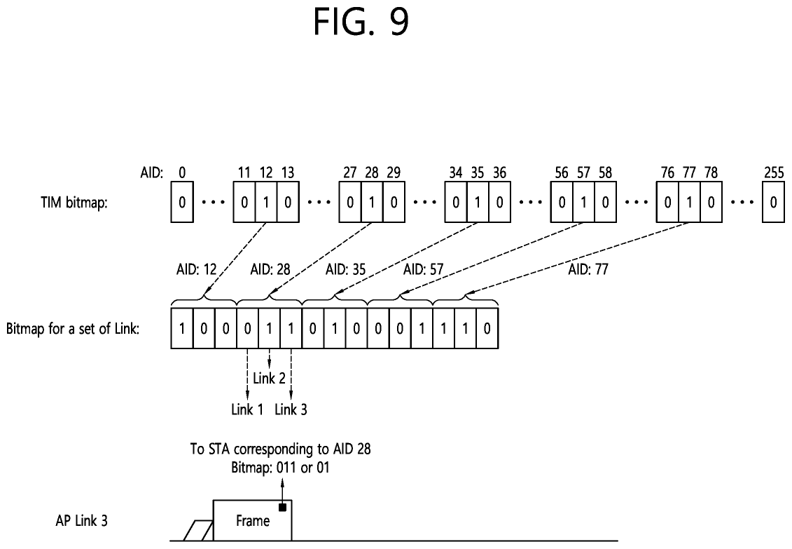

1) As Shown in FIG. 9, Indicating a Link Bitmap Related to a Link Through which Buffered Units (BUs) can be Transmitted.

FIG. 9 is a diagram showing an example of a TIM bitmap.

Referring to FIG. 9, since there are three links, Link 1, Link 2, and Link 3, and the link bitmap related to AID 28 is 011, a BU may be transmitted to an MLD corresponding to AID 28 on link 2 and/or link 3. For example, if the link bitmap related to AID 28 is 011, it may mean that traffic to be transmitted on link 2 and traffic to be transmitted on link 3 is present for the MLD corresponding to AID 28. For example, when the link bitmap related to AID 28 is 011, traffic to be transmitted on link 2 may be transmitted through another link. For example, even though the link bitmap associated with AID 28 is 011, all traffic to be transmitted to the MLD associated with AID 28 could be transmitted only through link 3. Therefore, when the link bitmap is 011, the MLD could determine which link to wake up from among link 2 and link 3. For example, the MLD may wake up at least one link among link 2 and link 3. A specific method related to which link the MLD wakes up is described below.

1-1) Always Wakes Up in a Link Indicated as “1” by the Link Bitmap.

In this case, since the STA always wakes up from the corresponding link, an issue according to the TID does not occur. That is, if only some of the STAs of the link indicated as 1 in the link bitmap wake up, a problem in which all BUs cannot be transmitted may occur. For example, if the link bitmap is indicated as 011, link 2 is mapped to TID 2 and 3, link 3 is mapped to TID 3, and AP MLD has traffic for non-AP MLD with TID 2 and 3, when the non-AP MLD wakes up only the STA operating on link 3, traffic for TID 2 may not be transmitted.

1-2) Select a Wake-Up Link from the Link Indicated as “1” by the Link Bitmap

In this case, the STA can wake up by selecting from the link indicated as “1”. For example, if TID 2 and 3 are mapped to Link 2 and TID 3 is mapped to Link 3, and the AP has traffic for a specific non-AP for TID 2 and 3, when the non-AP STA selects link 3, traffic for TID 2 cannot be received. That is, if the link bitmap is indicated as 011, link 2 is mapped to TID 2 and 3, link 3 is mapped to TID 3, and the AP MLD has traffic for non-AP MLD for TID 2 and 3, when the non-AP MLD wakes up only the STA operating on link 3, traffic for TID 2 may not be transmitted.

Therefore, additional instructions may be required. Additionally, information related to a link that needs to be woken up may be transmitted. Information related to a link that needs to be woken up can be transmitted in the form of a control field, such as A-control of 11ax, in a frame that is already being transmitted based on the TIM instruction. For example, as shown in the bottommost figure of FIG. 9, when the STA receives a BU on link 3, information related to a link that needs to wake up on link 3 can be transmitted. Information related to a link that needs to be woken up may be configured in a bitmap format. For example, information related to a link to be woken up may include a bitmap indicating whether to wake up for each link, such as a link bitmap. The information related to the link to be woken up may include information related to all links to be woken up (for example, 011), alternatively, information excluding a link (that is, link 3) through which information related to a link to be woken up is transmitted, that is, information excluding 1 bit (for example, 01) may be used. For example, if information related to a link that needs to wake up is transmitted through link 3, only information related to whether link 1 and link 2 are woken up can be transmitted.

That is, when the link bitmap indicates that link 2 and link 3 have BUs, the MLD receiving this can wake up only link 3. If link 2 also needs to be woken up, the transmitting MLD (for example, AP MLD) may transmit information that both link 2 and link 3 should be woken up to the receiving MLD. Therefore, through this, the STA of link 2 can wake up and receive traffic.

That is, the link bitmap may include information related to a link with a BU, information related to a link to be woken up that is additionally transmitted may include information related to which link should actually be woken up.

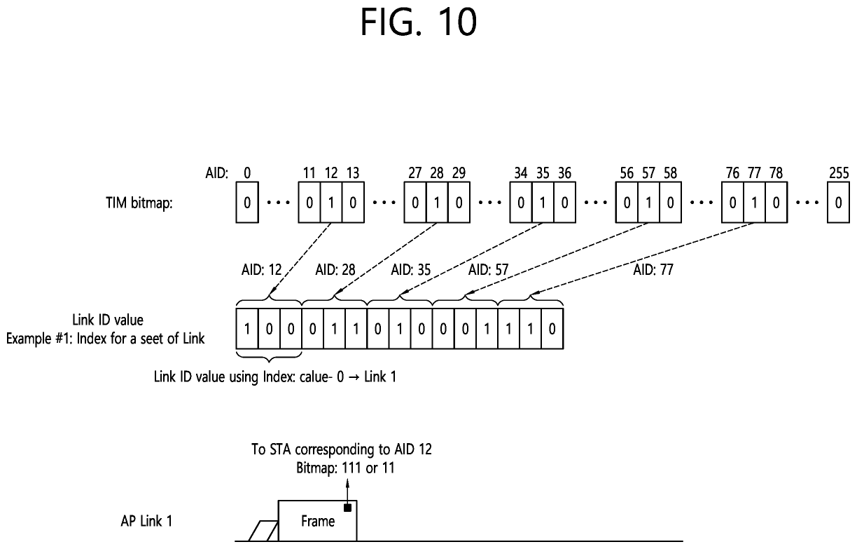

2) As Shown in FIG. 10, Indicating One Link ID to which the Corresponding BUs can be Delivered

FIG. 10 is a diagram showing an example of a TIM bitmap.

Referring to FIG. 10, a link ID value may be indicated in the form of an index, but is not limited thereto. For this index indication, it is necessary to map the link ID into an index form during the multi-link discovery/setup process. For example, if 3 bits are used, link 1 can be mapped in the form of 000 and link 2 in the form of 001. That is, when using 3 bits, up to 8 links can be expressed. In particular, this index method is applicable not only to multi-link TIM but also to other multi-link operations. Alternatively, Link ID may be used as it is.

For example, when 000 is mapped to link 1, the transmitting MLD may transmit information that traffic to be transmitted to the receiving MLD related to AID 12 is present through the TIM bitmap. In addition, if the link bitmap for the MLD related to AID 12 includes 000, the receiving MLD may wake up on the indicated link 1 (i.e., 000) (that is, a STA operating on link 1 could wake up). Since the link bitmap indicates only one link to wake up, additional instructions may be needed to indicate other links to be woken up. That is, there may be multiple links that need to be woken up. According to method 2), since only one link can be indicated, a way to indicate which other links should be woken up may be desired.

For example, as shown in the bottommost figure of FIG. 10, when the MLD receives a BU on link 1, a bitmap may be available on link 1. That is, if the link bitmap related to the AID of MLD is “000”, the MLD can wake up the STA on link 1 and receive signals over link 1. A signal (that is, frame) received through link 1 may include information related to a link to be woken up. For example, information related to a link to be woken up may be configured as a bitmap. The information related to the link to be woken up may include information related to whether all links are woken up (for example, 111), or may include information excluding its own link (that is, link 1), that is, information excluding 1 bit (for example, 11). That is, if the information related to whether to wake up includes a bitmap of 111, the receiving MLD can wake up not only link 1 but also STAs operating on links 2 and 3. Therefore, through this, the STAs of link 2 and link 3 can wake up and receive traffic.

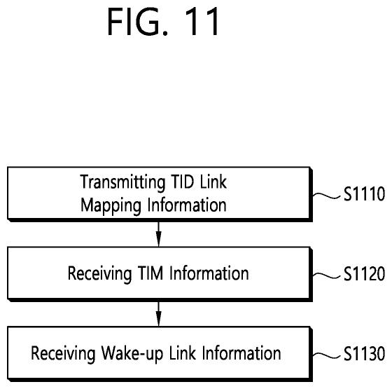

FIG. 11 is a diagram illustrating an embodiment of a STA MLD operation method.

Referring to FIG. 11, an STA MLD operation may be based on technical features described in at least one of FIGS. 1 to 10.

The STA MLD may transmit TID link mapping information (S1110). For example, the STA MLD may transmit traffic identifier (TID) link mapping information to the AP MLD. For example, the STA MLD may transmit or receive information related to which TID is mapped to the links it supports. For example, the STA MLD may transmit or receive information related to which TID is used for transmitting/receiving links supported by the STA.

The STA MLD may receive TIM information (S1120). For example, the STA MLD may receive traffic indication map (TIM) information from an access point (AP) MLD. For example, the TIM information may include a TIM bitmap and a link bitmap. For example, the TIM bitmap may include a bitmap related to whether data to be transmitted by the AP MLD to each receiving MLD is present, and the receiving MLD may include the STA MLD. For example, the link bitmap may include information related to a link of the receiving MLD, in which the data to be transmitted by the AP MLD is present, from among the receiving MLDs.

For example, the link bitmap may include a bitmap related to whether data to be transmitted by the AP MLD is present for each link of the receiving MLD of which data to be transmitted by the AP MLD is present.

For example, the link bitmap may include link ID information of a link to be woken up among a plurality of links in which a receiving MLD operates, in which data to be transmitted by the AP MLD is present.

For example, the TIM bitmap may indicate each receiving MLD based on an association identifier (AID).

The STA MLD may receive wake-up link information (S1130). For example, the STA MLD may receive wake-up link information from the AP MLD. For example, the wake-up link information may include information related to a link to be woken up from among the links of the STA MLD.

For example, the information related to the link to be woken up may be determined based on the TID link mapping information.

For example, the information related to the link to be woken up may include a bitmap related to whether each of a plurality of links in which the STA MLD operates needs to be woken up.

The STA MLD may transition an STA related to the link to be woken up from a doze state to an awake state, based on the information related to the link to be woken up.

1) Indicating a Link Bitmap Related to a Link Through which Buffered Units (BUs) can be Transmitted.

Since there are three links, Link 1, Link 2, and Link 3, and the link bitmap related to AID 28 is 011, a BU may be transmitted to an MLD corresponding to AID 28 on link 2 and/or link 3. For example, if the link bitmap related to AID 28 is 011, it may mean that traffic to be transmitted on link 2 and traffic to be transmitted on link 3 is present for the MLD corresponding to AID 28. For example, when the link bitmap related to AID 28 is 011, traffic to be transmitted on link 2 may be transmitted through another link. For example, even though the link bitmap associated with AID 28 is 011, all traffic to be transmitted to the MLD associated with AID 28 could be transmitted only through link 3. Therefore, when the link bitmap is 011, the MLD could determine which link to wake up from among link 2 and link 3. For example, the MLD may wake up at least one link among link 2 and link 3. A specific method related to which link the MLD wakes up is described below.

Always Wakes Up in a Link Indicated as “1” by the Link Bitmap.

In this case, since the STA always wakes up from the corresponding link, an issue according to the TID does not occur. That is, if only some of the STAs of the link indicated as 1 in the link bitmap wake up, a problem in which all BUs cannot be transmitted may occur. For example, if the link bitmap is indicated as 011, link 2 is mapped to TID 2 and 3, link 3 is mapped to TID 3, and AP MLD has traffic for non-AP MLD with TID 2 and 3, when the non-AP MLD wakes up only the STA operating on link 3, traffic for TID 2 may not be transmitted.

Select a Wake-Up Link from the Link Indicated as “1” by the Link Bitmap

In this case, the STA can wake up by selecting from the link indicated as “1”. For example, if TID 2 and 3 are mapped to Link 2 and TID 3 is mapped to Link 3, and the AP has traffic for a specific non-AP for TID 2 and 3, when the non-AP STA selects link 3, traffic for TID 2 cannot be received. That is, if the link bitmap is indicated as 011, link 2 is mapped to TID 2 and 3, link 3 is mapped to TID 3, and the AP MLD has traffic for non-AP MLD for TID 2 and 3, when the non-AP MLD wakes up only the STA operating on link 3, traffic for TID 2 may not be transmitted.

Therefore, additional instructions may be required. Additionally, information related to a link that needs to be woken up may be transmitted. Information related to a link that needs to be woken up can be transmitted in the form of a control field, such as A-control of 11ax, in a frame that is already being transmitted based on the TIM instruction. For example, as shown in the bottommost figure of FIG. 9, when the STA receives a BU on link 3, information related to a link that needs to wake up on link 3 can be transmitted. Information related to a link that needs to be woken up may be configured in a bitmap format. For example, information related to a link to be woken up may include a bitmap indicating whether to wake up for each link, such as a link bitmap. The information related to the link to be woken up may include information related to all links to be woken up (for example, 011), alternatively, information excluding a link (that is, link 3) through which information related to a link to be woken up is transmitted, that is, information excluding 1 bit (for example, 01) may be used. For example, if information related to a link that needs to wake up is transmitted through link 3, only information related to whether link 1 and link 2 are woken up can be transmitted.

That is, when the link bitmap indicates that link 2 and link 3 have BUs, the MLD receiving this can wake up only link 3. If link 2 also needs to be woken up, the transmitting MLD (for example, AP MLD) may transmit information that both link 2 and link 3 should be woken up to the receiving MLD. Therefore, through this, the STA of link 2 can wake up and receive traffic.

That is, the link bitmap may include information related to a link with a BU, information related to a link to be woken up that is additionally transmitted may include information related to which link should actually be woken up.

Indicating One Link ID to which the Corresponding BUs can be Delivered

A link ID value may be indicated in the form of an index, but is not limited thereto. For this index indication, it is necessary to map the link ID into an index form during the multi-link discovery/setup process. For example, if 3 bits are used, link 1 can be mapped in the form of 000 and link 2 in the form of 001. That is, when using 3 bits, up to 8 links can be expressed. In particular, this index method is applicable not only to multi-link TIM but also to other multi-link operations. Alternatively, Link ID may be used as it is.

For example, when 000 is mapped to link 1, the transmitting MLD may transmit information that traffic to be transmitted to the receiving MLD related to AID 12 is present through the TIM bitmap. In addition, if the link bitmap for the MLD related to AID 12 includes 000, the receiving MLD may wake up on the indicated link 1 (i.e., 000) (that is, a STA operating on link 1 could wake up). Since the link bitmap indicates only one link to wake up, additional instructions may be needed to indicate other links to be woken up. That is, there may be multiple links that need to be woken up. According to method 2), since only one link can be indicated, a way to indicate which other links should be woken up may be desired.

For example, as shown in the bottommost figure of FIG. 10, when the MLD receives a BU on link 1, a bitmap may be available on link 1. That is, if the link bitmap related to the AID of MLD is “000”, the MLD can wake up the STA on link 1 and receive signals over link 1. A signal (that is, frame) received through link 1 may include information related to a link to be woken up. For example, information related to a link to be woken up may be configured as a bitmap. The information related to the link to be woken up may include information related to whether all links are woken up (for example, 111), or may include information excluding its own link (that is, link 1), that is, information excluding 1 bit (for example, 11). That is, if the information related to whether to wake up includes a bitmap of 111, the receiving MLD can wake up not only link 1 but also STAs operating on links 2 and 3. Therefore, through this, the STAs of link 2 and link 3 can wake up and receive traffic.

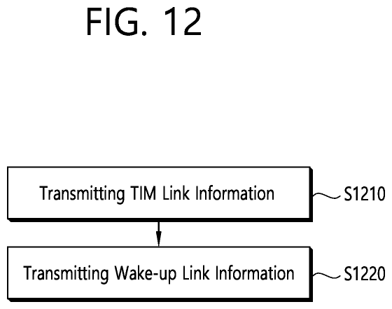

FIG. 12 is a diagram illustrating an embodiment of an AP MLD operating method.

Referring to FIG. 12, an AP MLD operation may be based on technical features described in at least one of FIGS. 1 to 10.

The AP MLD may receive TID link mapping information. For example, the AP MLD may transmit traffic identifier (TID) link mapping information to the STA MLD. For example, the AP MLD may transmit or receive information related to which TID is mapped to links supported by the STA MLD. For example, the AP MLD may transmit or receive information related to which TID is used for transmitting/receiving links supported by the STA MLD.

The AP MLD may transmit TIM link information (1210). For example, the AP MLD may transmit traffic indication map (TIM) information to a station (STA) MLD. For example, the TIM information may include a TIM bitmap and a link bitmap. For example, the TIM bitmap may include a bitmap related to whether data to be transmitted by the AP MLD to each receiving MLD is present, and the receiving MLD may include the STA MLD. For example, the link bitmap may include information related to a link of the receiving MLD, in which the data to be transmitted by the AP MLD is present, from among the receiving MLDs.

The AP MLD may transmit wake-up link information (S1220). For example, the AP MLD may transmit wake-up link information to the STA MLD. For example, the wake-up link information may include information related to a link to be woken up from among links of the STA MLD.

For example, the link bitmap may include a bitmap related to whether data to be transmitted by the AP MLD is present for each link of the receiving MLD of which data to be transmitted by the AP MLD is present.

For example, the link bitmap may include link ID information of a link to be woken up among a plurality of links in which a receiving MLD operates, in which data to be transmitted by the AP MLD is present.

For example, the TIM bitmap may indicate each receiving MLD based on an association identifier (AID).

For example, the information related to the link to be woken up may be determined based on the TID link mapping information.

For example, the information related to the link to be woken up may include a bitmap related to whether each of a plurality of links in which the STA MLD operates needs to be woken up.

Some of the detailed steps shown in the example of FIGS. 11 and 12 may be omitted. In addition to the steps shown in FIGS. 11 and 12, other steps may be added, and the order of the steps may vary. Some of the above steps may have their own technical meaning.

The technical features of the present disclosure described above may be applied to various devices and methods. For example, the above-described technical features of the present disclosure may be performed/supported through the apparatus of FIGS. 1 and/or 6. For example, the above-described technical features of the present disclosure may be applied only to a part of FIGS. 1 and/or 6. For example, the technical features of the present disclosure described above may be implemented based on the processing chips 114 and 124 of FIG. 1, may be implemented based on the processors 111 and 121 and the memories 112 and 122 of FIG. 1, or may be implemented based on the processor 610 and the memory 620 of FIG. 6. For example, the apparatus of the present disclosure includes a processor and a memory coupled to the processor. The processor may be adapted to receive traffic indication map (TIM) information from an access point (AP) MLD, wherein the TIM information includes a TIM bitmap and a link bitmap, wherein the TIM bitmap includes a bitmap related to whether data to be transmitted by the AP MLD to each receiving MLD is present, wherein the receiving MLD includes the STA MLD, wherein the link bitmap includes information related to a link of the receiving MLD, in which the data to be transmitted by the AP MLD is present, from among the receiving MLDs; and receive wake-up link information from an AP MLD, wherein the wake-up link information includes information related to a link to be woken up from among links of the STA MLD.

The technical features of the present disclosure may be implemented based on a computer readable medium (CRM). For example, CRM proposed by the present specification may store instructions which, based on being executed by at least one processor of a station (STA) MLD in a wireless local area network system, perform operations, the operations including: receiving traffic indication map (TIM) information from an access point (AP) MLD, wherein the TIM information includes a TIM bitmap and a link bitmap, wherein the TIM bitmap includes a bitmap related to whether data to be transmitted by the AP MLD to each receiving MLD is present, wherein the receiving MLD includes the STA MLD, wherein the link bitmap includes information related to a link of the receiving MLD, in which the data to be transmitted by the AP MLD is present, from among the receiving MLDs; and receiving wake-up link information from an AP MLD, wherein the wake-up link information includes information related to a link to be woken up from among links of the STA MLD.

The instructions stored in the CRM of the present disclosure may be executed by at least one processor. At least one processor related to CRM in the present disclosure may be the processors 111 and 121 or the processing chips 114 and 124 of FIG. 1, or the processor 610 of FIG. 6. Meanwhile, the CRM of the present disclosure may be the memories 112 and 122 of FIG. 1, the memory 620 of FIG. 6, or a separate external memory/storage medium/disk.

The foregoing technical features of this specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims set forth herein may be combined in a variety of ways. For example, the technical features of the method claims of the present specification may be combined to be implemented as a device, and the technical features of the device claims of the present specification may be combined to be implemented by a method. In addition, the technical characteristics of the method claim of the present specification and the technical characteristics of the device claim may be combined to be implemented as a device, and the technical characteristics of the method claim of the present specification and the technical characteristics of the device claim may be combined to be implemented by a method.

1. A method performed by a station (STA) multi-link device (MLD) in a wireless local area network (WLAN) system, the method comprising:
receiving traffic indication map (TIM) information from an access point (AP) MLD,
wherein the TIM information includes a TIM bitmap and a link bitmap,
wherein the TIM bitmap includes a bitmap related to whether data to be transmitted by the AP MLD to each receiving MLD is present, wherein the receiving MLD includes the STA MLD,
wherein the link bitmap includes information related to a link of the receiving MLD, in which the data to be transmitted by the AP MLD is present, from among the receiving MLDs; and
receiving wake-up link information from an AP MLD,
wherein the wake-up link information includes information related to a link to be woken up from among links of the STA MLD.

2. The method of claim 1, wherein the method further comprises,
transmitting, by the STA MLD, traffic identifier (TID) link mapping information to the AP MLD,
wherein the information related to the link to be woken up is determined based on the TID link mapping information.

3. The method of claim 1, wherein the method further comprises,
transitioning, by the STA MLD, an STA related to the link to be woken up from a doze state to an awake state, based on the information related to the link to be woken up.

4. The method of claim 1,
wherein the information related to the link to be woken up includes a bitmap related to whether each of a plurality of links in which the STA MLD operates needs to be woken up.

5. The method of claim 1,
wherein the link bitmap includes a bitmap related to whether data to be transmitted by the AP MLD is present for each link of the receiving MLD of which data to be transmitted by the AP MLD is present.

6. The method of claim 1,
wherein the link bitmap includes link ID information of a link to be woken up among a plurality of links in which a receiving MLD operates, in which data to be transmitted by the AP MLD is present.

7. The method of claim 1,
wherein the TIM bitmap indicates the each receiving MLD based on an association identifier (AID).

8. A station (STA) multi-link device (MLD) in a wireless local area network (WLAN) system, the STA MLD comprising:
a transceiver for transmitting and receiving a radio signal; and
a processor coupled to the transceiver, the processor is adapted to,
receive traffic indication map (TIM) information from an access point (AP) MLD,
wherein the TIM information includes a TIM bitmap and a link bitmap,
wherein the TIM bitmap includes a bitmap related to whether data to be transmitted by the AP MLD to each receiving MLD is present, wherein the receiving MLD includes the STA MLD,
wherein the link bitmap includes information related to a link of the receiving MLD, in which the data to be transmitted by the AP MLD is present, from among the receiving MLDs; and
receive wake-up link information from an AP MLD,
wherein the wake-up link information includes information related to a link to be woken up from among links of the STA MLD.

9. The STA MLD of claim 8, wherein the processor is further adapted to,
transmit traffic identifier (TID) link mapping information to the AP MLD,
wherein the information related to the link to be woken up is determined based on the TID link mapping information.

10. The STA MLD of claim 8, wherein the processor is further adapted to,
transition an STA related to the link to be woken up from a doze state to an awake state, based on the information related to the link to be woken up.

11. The STA MLD of claim 8,
wherein the information related to the link to be woken up includes a bitmap related to whether each of a plurality of links in which the STA MLD operates needs to be woken up.

12. The STA MLD of claim 8,
wherein the link bitmap includes a bitmap related to ‘whether data to be transmitted by the AP MLD is present for each link of the receiving MLD of which data to be transmitted by the AP MLD is present.

13. The STA MLD of claim 8,
wherein the link bitmap includes link ID information of a link to be woken up among a plurality of links in which a receiving MLD operates, in which data to be transmitted by the AP MLD is present.

14. The STA MLD of claim 8,
wherein the TIM bitmap indicates the each receiving MLD based on an association identifier (AID).

15. (canceled)

16. An access point (AP) multi-link device (MLD) in a wireless local area network (WLAN) system, the AP MLD is adapted to:
transmit traffic indication map (TIM) information from to a station (STA) MLD,
wherein the TIM information includes a TIM bitmap and a link bitmap,
wherein the TIM bitmap includes a bitmap related to whether data to be transmitted by the AP MLD to each receiving MLD is present, wherein the receiving MLD includes the STA MLD,
wherein the link bitmap includes information related to a link of the receiving MLD, in which the data to be transmitted by the AP MLD is present, from among the receiving MLDs; and
transmit wake-up link information to a STA MLD,
wherein the wake-up link information includes information related to a link to be woken up from among links of the STA MLD.

17-18. (canceled)
